(19) United States
(12) Patent Application Publication
(10) Pub. No.: US 2015/0278543 A1
(43) Pub. Date: Oct. 1, 2015

(54) System and Method for Optimizing Storage of File System Access Control Lists

(71) Applicant: FutureWei Technologies, Inc., Plano, TX (US)

(72) Inventors: Hengliang Zhang, Cupertino, CA (US); Alan Yoder, Sunnyvale, CA (US)

(21) Appl. No.: 14/225,271

(22) Filed: Mar. 25, 2014

(51) Int. Cl. G06F 21/62; G06F 17/30

(52) U.S. Cl. CPC G06F 21/6227; G06F 17/30091

(57) ABSTRACT

Embodiments are provided for improving storage of file ACLs. A plurality of ACLs are assigned corresponding unique ACL IDs and are stored in an indexed list. The indices of the ACLs in the list are mapped to the ACL IDs, which have a fixed defined size. The ACL ID for a given ACL is stored in a file or directory metadata structure. The ACL ID is then used to obtain the stored ACL, to determine for a user, access permission to the file or directory. The ACLs are stored once in the file system and their ACL IDs are duplicated, instead of the ACLs, in files as needed. Duplicating the ACL IDs instead of the ACLs in the files preserves storage space. Further, duplicating the ACL IDs instead of the ACLs in the files reduces the files sizes, which further improves file system efficiencies.

### TECHNICAL FIELD

The present invention relates to the field of file systems, and, in particular embodiments, to a system and method for optimizing storage of file system access control lists (ACLs).

### BACKGROUND

In modern file systems, Access Control Lists (ACLs) are used as a mechanism for determining whether a given user is authorized to access a file or other resource. The ACLs can have a substantial large size and hence require substantial storage space. Even when compressed, ACLs can represent a substantial storage overhead, especially in systems that store many files. Typically, the ACLs are of indeterminate length, and hence cannot be guaranteed to fit into an inode (index node) or other metadata structure of a fixed size. Furthermore, file systems typically may not have more than few thousands of ACLs, for example, even in systems with a much greater number of files (e.g., billions of files). There is a need for an efficient mechanism to store and use ACLs and minimize their storage overhead.

### SUMMARY OF THE INVENTION

In accordance with an embodiment of the disclosure, a method by a file processing component for managing Access Control Lists (ACLs) for a file system includes assigning for a plurality of ACLs a plurality of corresponding ACL IDs. The method further includes establishing a mapping between the ACLs and the corresponding ACL IDs, and storing a single occurrence of the ACLs in the file system. The ACL IDs are further added to files, thus indicating the corresponding ACLs for the files.

In accordance with another embodiment of the disclosure, a method by a file system processing component for managing ACLs for a file system includes receiving a user request to access a file. The request indicates a user ID or group ID. The method further comprises obtaining an ACL ID from metadata of the file, and obtaining, from a list of ACLs, an ACL matching the ACL ID. Upon detecting the user ID or group ID in the ACL, the method includes performing one of denying access to the file upon determining a deny access indication in an entry of the ACL, and allowing access to the file upon determining an allow access permission in the entry of the ACL.

In accordance with yet another embodiment of the disclosure, a file system component for managing ACLs for a file system includes at least one processor and a non-transitory computer readable storage medium storing programming for execution by the at least one processor. The programming includes instructions to assign for a plurality of ACLs a plurality of corresponding ACL IDs, and establish a mapping between the ACLs and the corresponding ACL IDs. The programming includes further instructions to store a single occurrence of the ACLs in the file system, and add the ACL IDs to files. The ACL IDs indicate the corresponding ACLs for the files.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example of an access control list (ACL);

FIG. 2 illustrates an embodiment of a data structure for efficiently storing ACL information for a file; and

FIG. 3 illustrates an embodiment of a method for accessing and using ACLs for a file;

FIG. 4 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

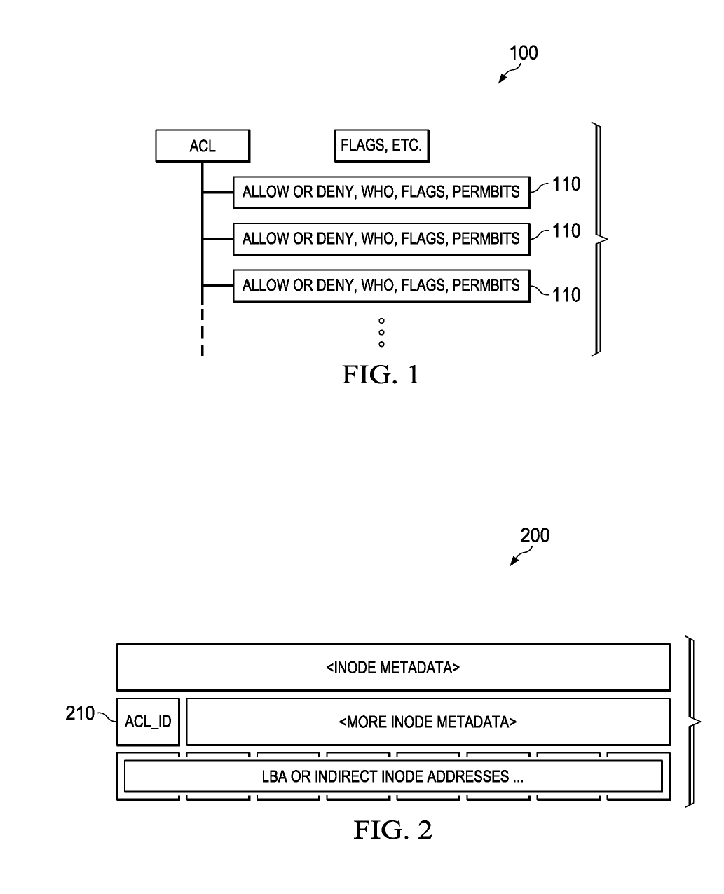

FIG. 1 shows an example of an access control list (ACL) 100. The ACL 100 is a list of Access Control Entries (ACEs). Each ACE includes an “allow” or “deny” indicator, a list of “who” (of users) belongs to this access entry, flags, permission bits, and possibly other information for managing file access. Given a set of user credentials, such as a user ID or group ID, the list of ACEs can be evaluated in order. Any ACE with a “who” that matches (or includes) the given user ID or group ID is used to either allow access or deny permission to the user as indicated in the entry.

Using the ACL can have issues affecting storage efficiency. For instance, the list of ACEs can be of arbitrary length. Further, ACLs are typically duplicated many times, for example for a large number of user file directories or files. However, user home file directories only have one unique ACL that is set at the top of the user's directory tree and inherited, and thus typically duplicated, by all the directories and files below it. Maintaining the duplicate copies requires considerable storage resource, e.g., on a hard disk or flash drive.

Embodiments are provided herein for improving storage of file ACLs. The embodiments resolve the issues of current ACL storage schemes and provide more efficient storage for ACLs. Specifically, unique ACLs are stored in an indexed list, where each ACL is assigned a different ACL ID. The ACL IDs can have a fixed defined size (e.g., different ACL IDs have the same size). The ACL ID is then stored in a file or directory metadata, such as the inode, instead of the corresponding ACL, thus preserving storage resource. The inode is a data structure used in Unix file systems to store information about a file system object (e.g., file, device node, socket, pipe). Since the ACLs are stored, for instance once, their ACL IDs are duplicated in files as needed, and storage space is substantially reduced. Further, the size of files or directory metadata is reduced, which can also further improve file system efficiencies. These mechanisms provide a low-overhead system which optimizes the use and storage of ACLs in file systems.

FIG. 2 illustrates an embodiment of a data structure 200 for efficiently storing ACL information for a file or file directory. The data structure 200 can be an inode or any other suitable metadata structure. The data structure 200 can be stored within the corresponding file and comprises metadata about the file, which is any data that described the file (e.g., size, data, location) excluding the actual content of the file. The metadata can also include Logical Block Addresses (LBAs) or inode addresses. Additionally, the inode includes the ACL ID for the file. The ACL ID indicates a unique ACL, which is stored somewhere else in the file system and is not included in the file. For instance, all the ACLs for a file system can be stored in a single directory or file (or a group of directories or files) designated for that purpose. The stored ACLs may include their corresponding ACL IDs. Additionally, a mapping between the ACLs and their ACL IDs can be established to facilitate lookup of ACL by ACL ID. The mapping can be established in a table or by indexing the ACLs in a list using their ACL IDs.

The number of expected ACLs, even in a substantially large file system, is not expected to exceed one million or may be on that order for example. User home directories, as well as other directory tree types, typically have a single unique ACL in the entire tree, which is propagated to new files and directories via inheritance. With a design point of one million ACLs, a 16-bit integer may not be large enough to use as an ACL ID. In this case, a 32-bit integer can be used for the ACL ID. In general, the bit-size of the ACL ID is chosen to guarantee enough unique numbers to cover the number of possible different ACLs in the file system.

In an embodiment, the ACL table, for mapping ACLs to ACL IDs, is dynamically allocated on the heap. Further, a pseudocode can be used to manage the ACL table management, such as:

| | |
|---|---|
| struct NACL = { n, ACL } | // numbered ACL |

//
// These two lists should use skiplists as data structures.
//

| | |
|---|---|
| list NACLs = [NACL by NACL.n] | // list ordered by ACL.n |

| | |
|---|---|
| list IACLs = [NACL by NACL.ACL] | // list ordered by ACL |
| | contents |

function GetACLbyID(id)

get nacl from NACLs skiplist
return nacl

end
function GetACLbyContents(acl)

get nacl from IACLs skiplist
return nacl

end
//
// This function is for setting an ACL. First, the function looks
// for an existing ACL that is the same as the one the
// user is setting. If not found, the function creates a new one.
//
function SetACL(acl, file)

nacl = GetACLbyContents(acl)
if (nacl == NULL)

| get nextid | |
|---|---|
| nacl = new NACL(nextid, acl) | |
| insert nacl into NACLs | // no locking |

required

| | |
|---|---|
| insert nacl into IACLs | // no locking required |

increment nextid

endif

set nacl.n on file metadata

end
//
// This is the basic ACL evaluation mechanism.
//
function AuthorizeAccess(userid, groups, requestbits)

| get aclid from file metadata | |
|---|---|
| nacl = GetACLbyID(aclid) | |
| bits = 0 | // unsigned |

32-bit bitmask

for each ace in nacl.ACL

//
// only ACEs pertaining to the user and her groups
// get processed
//
if ace.who == userid or ace.who is in groups list

//
// DENY ACEs cause denial of request if any of the
// requested bits intersect the DENY ace permissions
// bitmask.
//
if ace is a DENY ACE

if ace.perms & requestbits != 0

DENY access immediately

endif

//
// ALLOW ACEs cause accumulation of permissions until
all
// the requested permissions bits have been ALLOWed
//
else if ace is an ALLOW ACE

bits |= ace.perms

endif

endif
if bits & requestbits == requestbits

ALLOW access immediately

endif

| endfor | |
|---|---|
| DENY access | // insufficient permissions |

end

The pseudocode above creates two lists of ordered ACLs, by index (n) and by content. Further, the function GetACLbyID is defined to obtain an ACL using an indicated ACL ID. This can be done by mapping the ACL IDs to the indices (n's) of teh ACLs, e.g., in a mapping table. The function GetACLbyContents is defined to obtain an ACL using indicated ACL content. The function SetACL is defined to create a new ACL. The function AuthorizeAccess is defined to evaluate file access according to an indicated ACL ID and corresponding ACL information. The function gets the ACL ID from the file metadata (e.g., the inode). The function checks in the list of ACLs for an ACL that matches the ACL ID. Sorting the ACLs in the list according to their indices (n's) simplifies the search for the target ACL (the ACL corresponding to the indicated ACL ID in the file's metadata. If found, the function determines whether the provided user ID or user group belongs to a deny access list or allow access list and accordingly deny or allow the user access to the file.

The ACE and ACL structures in the pseudo code above can be stored as data structures, e.g., using C programming language as:

struct ace {

| | | |
|---|---|---|
| unsigned int32 | what; | // ALLOW, DENY, etc. |
| unsigned int32 | flags; | |
| unsigned int32 | perms; | |
| unsigned int32 | who; | |

| | |
|---|---|
| struct ace* | next; |

| | |
|---|---|
| ... | // there may be more |

}
struct acl {

| | |
|---|---|
| unsigned int32 | aclid; |

| | | |
|---|---|---|
| unsigned int32 | flags; | // for inheritance etc. |

| | | |
|---|---|---|
| unsigned int32 | mode; | // Unix perms |

| | | |
|---|---|---|
| struct ace* | aces; | // linked list of ACEs |

}

According to the data structures above, a typical ACL with three ACEs for example uses 76 bytes of storage at a minimum, and probably more, in a data structure that is not bounded in size. This motivates the use of the ACL ID and sharing the ACL ID among files (within a directory tree) instead of duplicating the ACL. However, it may be rare to have more than a few thousand ACLs in a given file system. This means that a file containing all the ACLs in the two lists may rarely be over a megabyte in size. Furthermore, since the file entries do not need to change, the file can be an append-only file, where content is appended at end of file without changing existing content. Thus, the following policies may be used. In one policy, when new ACLs are created (e.g., a rare event), the new ACL is appended to the file in a non-volatile storage medium (e.g., hard drive). In yet another policy, when the system boots, it may read the file into flash memory or Read Only Memory (RAM), and pin it there. This is recommended but not absolutely necessary. It is also possible that the normal buffering mechanisms can keep ACLs that are in much use in memory.

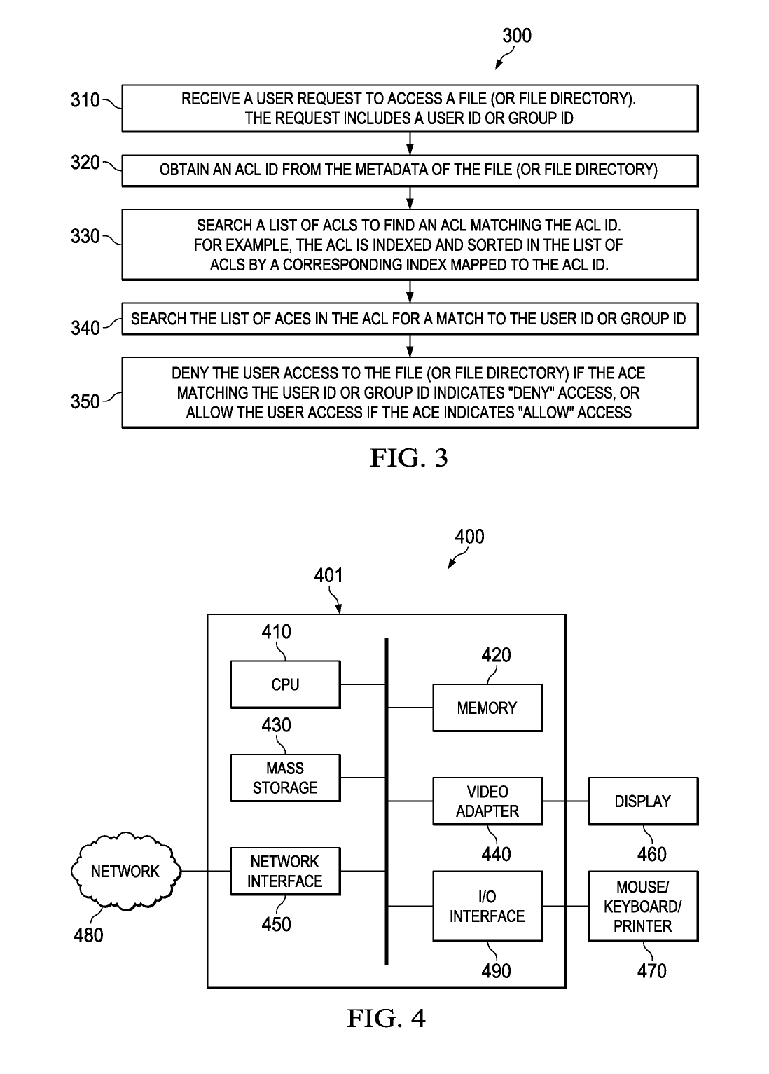

FIG. 3 shows an embodiment of a method 300 for accessing and using ACLs for a file. Specifically, the method 300 uses an ACL ID to locate a corresponding ACL in a list of ACLs and hence determine user access permission to a file. At step 310, the file system receives a user request to access a file (or file directory). The request includes a user ID or group ID. At step 320, an ACL ID is obtained from the metadata of the file (or file directory). At step 330, a list of ACLs is searched to find an ACL matching the ACL ID. The ACL may be indexed and sorted in the list of ACLs by corresponding indices, which may be mapped to the corresponding ACL IDs in a mapping structure such as a table or the like. At step 340, the list of ACEs in the ACL are searched for a match to the user ID or group ID. At step 350, the user is denied access to the file (or file directory) if the ACE matching the user ID or group ID indicates “deny” access, or is allowed access if the ACE indicates “allow” access.

In the case no match to the user ID or group ID is found in the list of ACEs in the ACL or no match to the ACL ID is found, the user is denied access to the file. Further, an ACL can be removed from a file or directory by removing the ACL ID corresponding to that ACL form the mapping. Use access permissions to files or directories can also be changed by changing the ACL IDs in the files or directories without the need to change the ACLs.

FIG. 4 is a block diagram of an exemplary processing system 400 that can be used to implement various embodiments. The processing system is part of a file system processing component, such as a file server, a computer workstation, a network component, or other suitable processing component. The processing system 400 may comprise a processing unit 401 equipped with one or more input/output devices, such as a speaker, microphone, mouse, touchscreen, keypad, keyboard, printer, display, and the like. The processing unit 401 may include a central processing unit (CPU) 410, a memory 420, a mass storage device 430, a video adapter 440, and an Input/Output (I/O) interface 490 connected to a bus. The bus may be one or more of any type of several bus architectures including a memory bus or memory controller, a peripheral bus, a video bus, or the like.

The CPU 410 may comprise any type of electronic data processor. The memory 420 may comprise any type of system memory such as static random access memory (SRAM), dynamic random access memory (DRAM), synchronous DRAM (SDRAM), read-only memory (ROM), a combination thereof, or the like. In an embodiment, the memory 420 may include ROM for use at boot-up, and DRAM for program and data storage for use while executing programs. The mass storage device 430 may comprise any type of storage device configured to store data, programs, and other information and to make the data, programs, and other information accessible via the bus. The mass storage device 430 may comprise, for example, one or more of a solid state drive, hard disk drive, a magnetic disk drive, an optical disk drive, or the like.

The video adapter 440 and the I/O interface 490 provide interfaces to couple external input and output devices to the processing unit. As illustrated, examples of input and output devices include a display 460 coupled to the video adapter 440 and any combination of mouse/keyboard/printer 470 coupled to the I/O interface 490. Other devices may be coupled to the processing unit 401, and additional or fewer interface cards may be utilized. For example, a serial interface card (not shown) may be used to provide a serial interface for a printer.

The processing unit 401 also includes one or more network interfaces 450, which may comprise wired links, such as an Ethernet cable or the like, and/or wireless links to access nodes or one or more networks 480. The network interface 450 allows the processing unit 401 to communicate with remote units via the networks 480. For example, the network interface 450 may provide wireless communication via one or more transmitters/transmit antennas and one or more receivers/receive antennas. In an embodiment, the processing unit 401 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method by a file processing component for managing Access Control Lists (ACLs) for a file system, the method comprising:
assigning for a plurality of ACLs a plurality of corresponding ACL IDs;
establishing a mapping between the ACLs and the corresponding ACL IDs;
storing a single occurrence of the ACLs in the file system; and
adding the ACL IDs to files, the ACL IDs indicating the corresponding ACLs for the files.

2. The method of claim 1, wherein the ACL IDs are added to metadata in the files.

3. The method of claim 2, wherein the metadata is an inode data structure in the files.

4. The method of claim 1, wherein establishing the mapping between the ACLs and the corresponding ACL IDs comprises:
adding the ACLs with corresponding indices to a list;
indexing the ACLs by the corresponding indices;
sorting the ACLs in the list according to the corresponding indices; and
mapping the indices of the ACLs to the corresponding ACL IDs in a mapping table.

5. The method of claim 4 further comprising adding a new ACL by appending the new ACL to the list.

6. The method of claim 1 further comprising adding an ACL ID corresponding to an ACL from the ACLs to each file in a file directory associated with the ACL.

7. The method of claim 1 further comprising removing, from a file, access permission according to an ACL by removing an ACL ID corresponding to the ACL from metadata of the file, wherein the access permission is for a user or user group.

8. The method of claim 1 further comprising changing, in a file, access permission according to an ACL by changing an ACL ID in metadata of the file, wherein the access permission is for a user or user group

9. A method by a file system processing component for managing Access Control Lists (ACLs) for a file system, the method comprising:
receiving a user request to access a file, the request indicating a user ID or group ID;
obtaining an ACL ID from metadata of the file;
obtaining, from a list of ACLs, an ACL matching the ACL ID; and
upon detecting the user ID or group ID in the ACL, performing one of denying access to the file upon determining a deny access indication in an entry of the ACL, and allowing access to the file upon determining an allow access permission in the entry of the ACL.

10. The method of claim 9, wherein obtaining, from the list of ACLs, the ACL matching the ACL ID comprises searching the list of ACLs for an index matching or mapped to the ACL ID.

11. The method of claim 10, wherein the ACLs in the list are indexed and sorted by corresponding indices.

12. The method of claim 9 further comprising:
searching a list of ACEs in the ACL for a match to the user ID or group ID;
obtaining an ACE form the list of ACEs that includes a matching user ID or group ID; and
determining whether the ACE includes the deny access indication or the allow access permission.

13. The method of claim 9 further comprising denying access to the file if the user ID or group ID is not found in the ACL.

14. The method of claim 13 further comprising searching a list of ACEs in the ACL for a match to the user ID or group ID, wherein access to the file is denied if no match to the user ID or group ID is found in the list of ACEs.

15. A file system component for managing Access Control Lists (ACLs) for a file system, the file system component comprising:
at least one processor; and
a non-transitory computer readable storage medium storing programming for execution by the at least one processor, the programming including instructions to:
assign for a plurality of ACLs a plurality of corresponding ACL IDs;
establish a mapping between the ACLs and the corresponding ACL IDs;
store a single occurrence of the ACLs in the file system; and
add the ACL IDs to files, the ACL IDs indicating the corresponding ACLs for the files.

16. The file system component of claim 15, wherein each of the files that belong to a same directory tree associated with an ACL of the ACLs comprise a same ACL ID corresponding to the ACL.

17. The file system component of claim 15, wherein a file of the files associated with multiple ACLs includes, in a metadata of the file, multiple ACL IDs corresponding to the multiple ACLs.

18. The file system component of claim 15, wherein the ACLs are stored in a file in the non-transitory computer readable storage medium or a non-volatile storage medium, and wherein the programming includes further instructions to, upon creating a new ACL, append the new ACL to the non-transitory computer readable storage medium or the non-volatile storage medium.

19. The file system component of claim 15, wherein the programming includes further instructions, upon booting the file system component, reading the file into a volatile memory medium and pinning the volatile memory medium.

20. The file system component of claim 16, wherein the programming includes further instructions to:
receive a user request to access a file of the files, the request indicating a user ID or group ID;
obtain an ACL ID from metadata of the file;
obtain, from the ACLs, an ACL matching the ACL ID; and
upon detecting the user ID or group ID in the ACL, perform one of deny access to the file upon determining a deny access indication in an entry of the ACL, and allow access to the file upon determining an allow access permission in the entry of the ACL.
